(19) United States
(12) Patent Application Publication
(10) Pub. No.: US 2019/0313004 A1
(43) Pub. Date: Oct. 10, 2019

(54) LIGHT-EMITTING APPARATUS FOR SHOOTING WITH FLASH, CHARGING CONTROL METHOD THEREFOR, AND STORAGE MEDIUM

(71) Applicant: CANON KABUSHIKI KAISHA, Tokyo (JP)

(72) Inventors: Yukihiro Matsumoto, Kawaguchi-shi (JP); Junji Takai, Yokohama-shi (JP)

(21) Appl. No.: 16/369,486

(22) Filed: Mar. 29, 2019

(30) Foreign Application Priority Data
Apr. 4, 2018 (JP) 2018-072585

(51) Int. Cl. H04N 5/235; G03B 15/05; H05B 33/08; H02J 7/00

(52) U.S. Cl. CPC H04N 5/2354; G03B 15/05; H05B 33/0845; H02J 7/345; H04N 5/2351; G03B 2215/0567; H02J 7/007

(57) ABSTRACT

A light-emitting apparatus which capable of preventing the perfect moment to take a photograph from being missed while reducing draining of a charging unit caused by charging thereof. In accordance with an instruction from a camera 100, a flash MPU of an external flash 120 switches to perform one of a first charging control and a second charging control in accordance with a first instruction from the camera 100. The first charging control charges the charging unit 202 until a charging voltage thereof reaches a target first level and then maintains the charging level at the first level, and the second charging control charges said charging unit 202 until the charging voltage reaches the first level when the charging voltage reaches a second level lower than the first level.

### BACKGROUND OF THE INVENTION

### Field of the Invention

The present invention relates to a light-emitting apparatus, a charging control method therefor, and a storage medium, and in particular to a light-emitting apparatus and a charging control method therefor which are for use in shooting with a flash, as well as a storage medium.

### Description of the Related Art

Conventionally, a flash has been used for shooting in a dark scene, a back-light scene, and so forth.

A function of causing a camera to automatically judge whether or not to use the flash in shooting is known as an auto light-emission function.

Shooting with the flash is conducted as follows: a capacitor connected to a light-emitting unit of the flash is charged with electric charge to a level at which light emission by the light-emitting unit is possible, and then the light-emitting unit is caused to emit light by feeding the electric charge into the light-emitting unit.

The amount of light emitted by the light-emitting unit of the flash is proportional to the amount of electric charge that has charged the capacitor, and hence the amount of electric charge is monitored with a voltage (hereafter referred to as “charging voltage”) of the capacitor. Namely, the charging voltage that obtains the best light emission performance of the flash is a voltage (hereafter referred to as “full charging level”) close to a withstand voltage of the capacitor.

On the other hand, there is a minimum voltage (hereafter referred to as “light emission possible level”) required for the light-emitting unit of the flash to emit light.

Conventionally, charging of the capacitor has been controlled such that that the full charging level is always maintained so as to obtain the best performance of light emission by the light-emitting unit of the flash.

The charging voltage, however, is required to be at the full charging level when a release switch is operated to prepare for a shooting instruction, thus it wastes power that the charging voltage is maintained at the full charging level even during standby for an operation on the release switch after starting of the camera wastes power.

Particularly when the auto light-emission function is running, the camera automatically judges whether or not to fire a flash, and hence maintaining the charging voltage at the full charging level even during standby for an operation on the release switch results in waste of power.

On the other hand, if the capacitor is not charged until the release switch is operated after the capacitor is charged up to the full charging level, the electric charge in the capacitor may be self-discharged, causing the charging voltage to become lower than the light emission possible level during shooting with the flash. In this case, the perfect moment to take a photograph is missed because of a release time lag caused by charging of the capacitor.

According to Japanese Laid-Open Patent Publication (Kokai) No. 2016-057485, while SW1 is on, the charging voltage is held at a voltage threshold level ThH required to fire a flash, and otherwise, the charging voltage is held at a voltage threshold level ThL, which is lower than the voltage threshold level ThH, during standby. This reduces the time period required for the charging voltage to reach a voltage threshold level ThH while increasing durability of the capacitor.

According to Japanese Laid-Open Patent Publication (Kokai) No. 2016-057485, however, a discharge control unit provides control to intentionally discharge the electric charge in the capacitor during standby, and after the charging voltage reaches the voltage threshold level ThL, a charging control unit holds the charging voltage at the voltage threshold level ThL. The purpose of holding the charging voltage at the voltage threshold level ThL is to increase durability of the capacitor, and hence the voltage threshold level ThL is not always equal to or higher than the light emission possible level.

For this reason, it is necessary to always recharge the capacitor from the voltage threshold level ThL to the voltage threshold level ThH when taking a photograph. As a result, draining of the capacitor increases, and additional charging time is needed.

### SUMMARY OF THE INVENTION

The present invention provides a light-emitting apparatus and a charging control method therefor which are capable of preventing the perfect moment to take a photograph from being missed while reducing draining of a charging unit of the light-emitting apparatus caused by charging thereof, as well as a storage medium.

Accordingly, the present invention provides a light-emitting apparatus comprising a light-emitter, a charging unit configured to have a capacitor and to be charged with electrical charge for causing the light-emitter to emit light, and at least one processor and at least one memory functioning as a switching unit configured to switch to perform one of a first charging control and a second charging control wherein in the first charging control charges the charging unit until a charging voltage of the charging unit reaches a target first level and then maintains the charging level at the first level, and the second charging control charges the charging unit until the charging voltage reaches the first level when the charging voltage reaches a second level lower than the first level.

According to the present invention, the perfect moment to take a photograph is prevented from being missed while draining of a charging unit of a light-emitting apparatus caused by charging thereof is reduced.

Further features of the present invention will become apparent from the following description of exemplary embodiments (with reference to the attached drawings).

### BRIEF DESCRIPTION OF THE DRAWINGS

FIG. 1 is a block diagram showing an arrangement of a camera on which an external flash which is a light-emitting apparatus according to a first embodiment of the present invention is mounted and which is integrated with a built-in flash which is the light-emitting apparatus.

FIG. 2 is a block diagram showing an arrangement of the external flash.

FIG. 3 is a view useful in briefly explaining first charging control.

FIG. 4 is a view useful in briefly explaining how to switch between the first charging control and second charging control according to the present invention.

FIG. 5A is a flowchart showing a charging control process according to the first embodiment of the present invention.

FIG. 5B is continued from FIG. 5A.

FIG. 6A is a flowchart showing a variation of the charging control process according to the first embodiment of the present invention.

FIG. 6B is continued from FIG. 6A.

FIG. 7 is a view useful in briefly explaining third charging control according to the present invention.

FIG. 8A is a flowchart showing a charging control process according to the second embodiment.

FIG. 8B is continued from FIG. 8A.

### DESCRIPTION OF THE EMBODIMENTS

The present invention will now be described in detail below with reference to the accompanying drawings showing embodiments thereof.

### First Embodiment

### (Basic Arrangement of Camera)

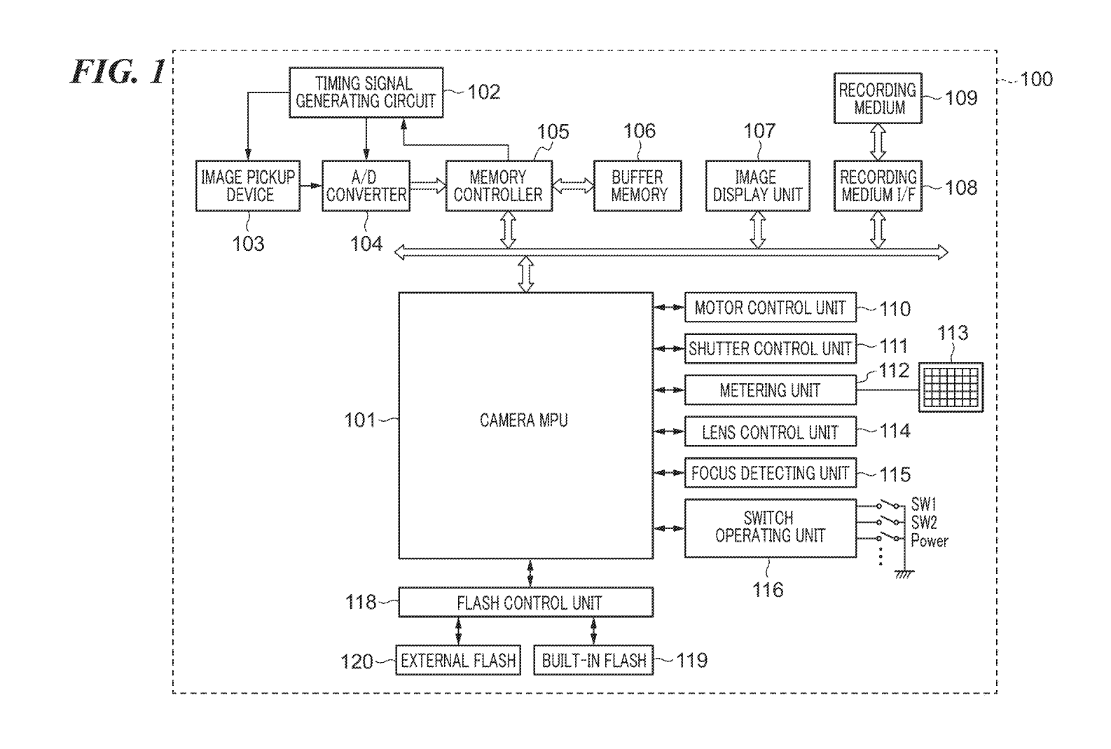

FIG. 1 is a block diagram showing an arrangement of a digital camera (hereafter simply referred to as “the camera”) 100 on which an external flash 120 which is a light-emitting apparatus according to a first embodiment of the present invention is mounted and which is integrated with a built-in flash 119 which is the light-emitting apparatus.

It should be noted that one or more of component elements of the camera 100 shown in FIG. 1 may be implemented by hardware such as an ASIC and a programmable logic array (PLA). They may also be implemented by a programmable processor such as a CPU or an MPU executing software.

They may also be implemented by a combination of software and hardware.

Therefore, in the following description, even when different component elements are described as operating entities, the same hardware may be implemented as the operating entities.

The camera 100 has a camera MPU (hereafter simply referred to as “the MPU”) 101, a timing signal generating circuit 102, an image pickup device 103, an A/D converter 104, a memory controller 105, a buffer memory 106, a recording medium I/F (hereafter simply referred to as “the interface”) 108, and a recording medium 109.

The MFP 101 is a microcontroller of the camera 100, which is for controlling a system in such as a shooting sequence. The image pickup device 103 is comprised of a CCD, a CMOS, or the like which converts reflected light from a subject into an electric signal. The timing signal generating circuit 102 generates a timing signal required to operate the image pickup device 103.

The A/D converter 104 performs analog-to-digital conversion of analog image data read out from the image pickup device 103 into digital image data. The memory controller 105 controls reading and writing of data to and from the buffer memory 106, refreshing of the buffer memory 105, and so forth.

The image display unit 107 displays image data accumulated in the buffer memory 106. The interface 108 is for connecting the recording medium 109 to the camera 100. The recording medium 109 is comprised of a memory card, a hard disk, or the like.

The camera 100 also has a motor control unit 110, a shutter control unit 111, a metering unit 112, a multi-zone photometric sensor 113, a lens control unit 114, a focus detecting unit 115, a switch operating unit 116, and a flash control unit 118.

The motor control unit 110 flips a mirror, not shown, up and down and charges a shutter, not shown, by controlling motors, not shown, in accordance with signals from the MPU 101 when an exposure of the image pickup device 103 is performed.

The shutter control unit 111 controls the exposure of the image pickup device 103 by controlling the shutter in accordance with signals from the MPU 101.

The metering unit 112 outputs an output from the multi-zone photometric sensor 113, which divides a sensor area into a plurality of areas and measures brightness in each area, as a luminance signal to the MFP 101 when the exposure is adjusted to take a photograph. The MPU 101 causes the A/D converter 104 to perform analog-to-digital conversion of the luminance signal. Based on the conversion result, the MPU 101 performs photometric computations to find an aperture (Av) of a diaphragm, not shown, for use in adjusting the exposure to take a photograph, a control value Tv (shutter speed) to be used by the shutter control unit 111, an ISO sensitivity (a sensitivity of the image pickup device 103), and so forth.

The metering unit 112 also outputs a luminance signal, which is generated when the external flash 120 or the built-in flash 119 fires a pre-flash at a subject, to the MPU 101. The MPU 101 causes the A/D converter 104 to perform analog-to-digital conversion of the luminance signal, and based on the conversion result, computes the amount of light emitted when a flash photograph is actually taken using the external flash 120 or the built-in flash 119 (hereafter referred to as “the amount of light emitted by main flash”).

It should be noted that the MPU 101 may not use an output from the multi-zone photometric sensor 113 but use image data taken by the image pickup device 103 to perform the above described photometric computations and compute the amount of light emitted by main flash.

The lens control unit 114 communicates with a lens MPU, not shown, via a lens mount contact, not shown, to run a lens driving motor and a lens diaphragm motor, not shown, to adjust the focus of a lens, not shown, and control the diaphragm.

The focus detecting unit 115 detects a defocus amount of a subject so as to perform AF (auto-focusing).

The switch operating unit 116 is comprised of a release switch, a power switch, and other switches, not shown. Upon detecting a user operation on any of these switches, the switch operating unit 116 switches on or off one of SW1, SW2, “Power”, or the like connected to the switch operating unit 116 based on the detection result. The switch operating unit 116 also sends a detection signal indicating of turning-on or off of SW1, SW2, “Power”, or the like to the MPU 101 when the user operation is detected. Here, SW1 is switched on when the switch operating unit 116 detects a first stroke (pressing halfway down) on a release button by the user. Upon receiving a detection signal indicating turning-on of SW1 from the switch operating unit 116, the MPU 101 starts preparing for taking a photograph. Specifically, the MPU 101 starts AF (distance measurement) and metering. Moreover, SW2 is switched on when the switch operating unit 116 detects a second stroke (pressing all the way down) on a release button by the user. Upon receiving a detection signal indicating turning-on of SW2 from the switch operating unit 116, the MPU 101 takes a photograph. Specifically, the MPU 101 starts exposure. “Power” is switched on when the switch operating unit 116 detects the user having switched the power switch from off to on. Electric power is supplied to the MPU 101 when the MPU 101 receives a detection signal indicating turning-on of “Power” from the switch operating unit 116. When electric power is supplied to the MPU 101, the MPU 101 comes into a shooting instruction waiting state in which it waits for a user operation to be performed on any of the release switches (SW1, SW2) and the other switches and provides control suitable for the user operation.

Namely, when any of SW1, SW2, “Power”, or the like is switched on or off in the switch operating unit 116, a signal indicating thereof is sent from the switch operating unit 116 to the MPU 101.

The flash control unit 118 provides control to switch one of light emission patterns (i.e. switching one of a pre-flash instruction or main flash instruction), switch one of light emission amount computation processes for computing the amount of light emitted by main flash or the like, and selectively use the built-in flash 119 and the external flash 120.

MPU 101 carries out communications with the built-in flash 119 and the external flash 120 by way of the flash control unit 118.

It should be noted that in the first embodiment, although not only the external flash 120 is mounted on the camera 100 but also the built-in flash 119 is incorporated in the camera 100, at least one of them has only to be used as the light-emitting apparatus according to the first embodiment and be able to communicate with the camera 100.

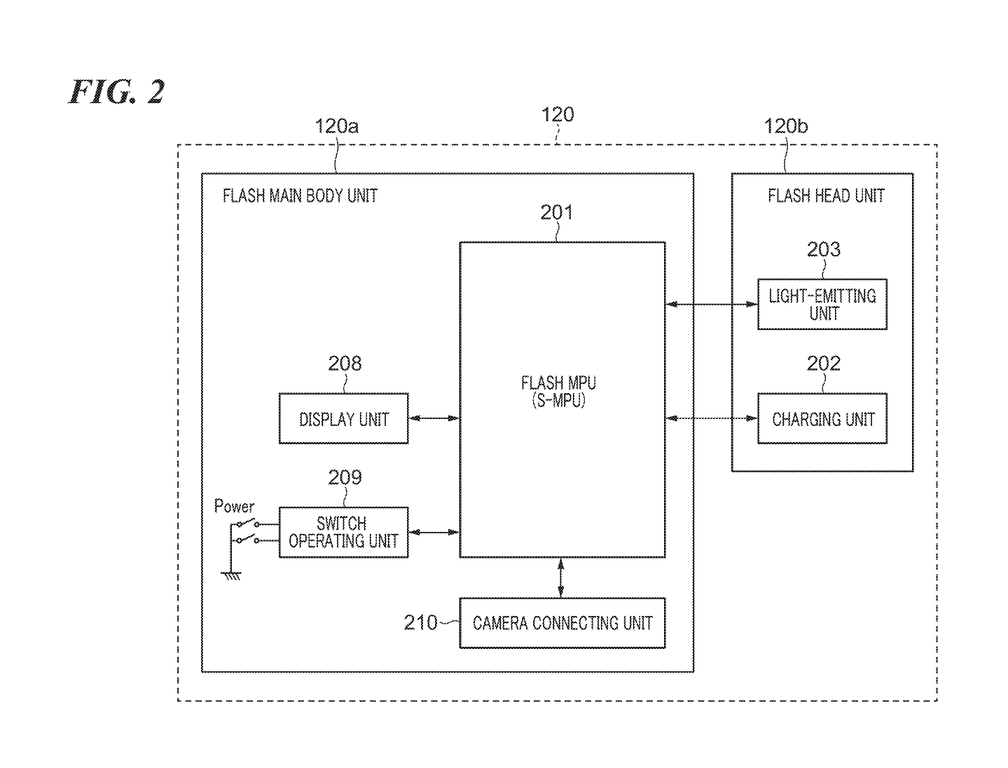

A description will now be given of an arrangement of the external flash 120 with reference to FIG. 2.

The external flash 120 is comprised of a flash main body unit 120a and a flash head unit 120b. The flash main body unit 120a has a flash MPU (hereafter referred to as “the S-MPU”) 201, a display unit 208, a switch operating unit 209, and a camera connecting unit 210. The flash head unit 120b has a charging unit 202 and a light-emitting unit 203.

The S-MPU 201 is a microcontroller of the external flash 120, which is intended to control systems for functioning the external flash 120 such as an electric power supply sequence, a charging sequence, a light emission control sequence.

The charging unit 202 has a main capacitor which is charged by a booster circuit, not shown, and outputs a main capacitor voltage (hereafter referred to as “the charging voltage”) to the S-MPU 201. Also, in accordance with an instruction from the S-MPU 201, the charging unit 202 feeds electric charge, which has charged the main capacitor, into the light-emitting unit 203 so as to emit a flash light.

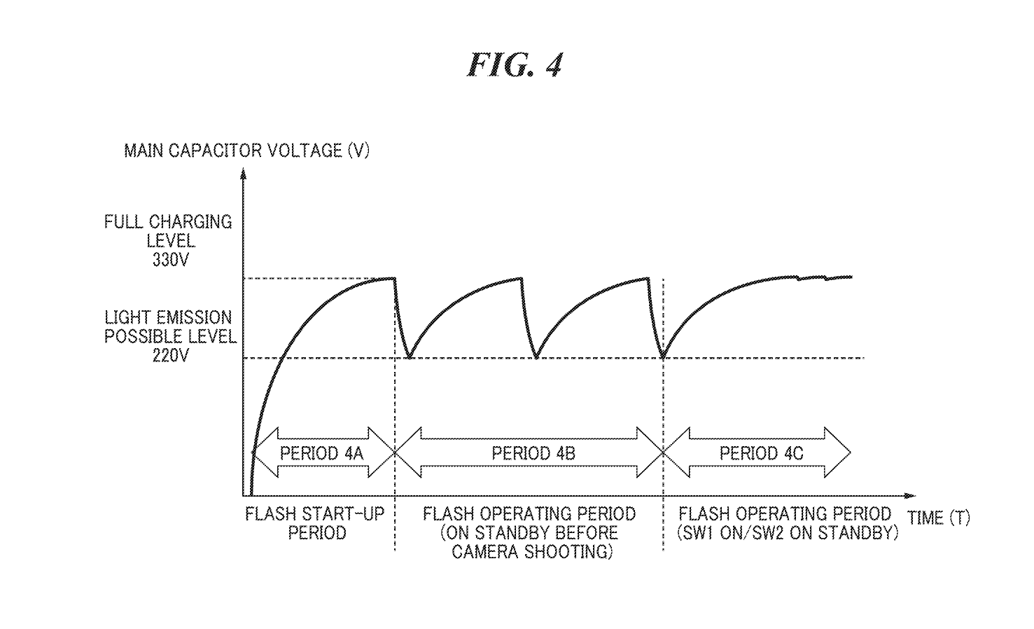

The S-MPU 201 causes an A/D converter, not shown, to perform analog-to-digital conversion of the charging voltage output from the charging unit 202, and based on the conversion result, performs a computation such as a determination as to whether the charging voltage is at a level (hereafter referred to as “the light emission possible level”: the second level) at which only emitting of a flash light is possible or at a level (hereafter referred to as “the full charging level”: the first level) at which a flash light can be emitted to a maximum extent and which is higher than the light emission possible level. In accordance with the computation result and as a result of charging control, to be described later with reference to FIG. 4, the S-MPU 201 instructs the charging unit 202 to feed the electric charge, which has charged the main capacitor, into the light-emitting unit 203. Here, in the first embodiment, the full charging level means a level close to a withstand voltage of the main capacitor in the charging unit 202.

The light-emitting unit 203 has a light-emitting circuit, not shown, which emit a flash light in accordance with a light emission signal from the S-MPU 201.

The display unit 208 displays, for example, completion/incompletion of charging in the charging unit 202. Specifically, when the S-MPU 201 determines that the charging voltage is at the light emission possible level or the full charging level, the display unit 208 turns on an LED lamp, not shown, to notify the user that a flash light can be emitted.

The switch operating unit 209 is comprised of one or more buttons/switches, not shown, and upon detecting a user operation on any of these buttons/switches, the switch operating unit 209 selectively switches on or off “Power” or the like connected to the switch operating unit 209 according to the detection result. Also, upon detecting the user operation, the switch operating unit 209 sends a detection signal indicating turning on or off of “Power” of the like to the S-MPU 201. When “Power” is switched on, electric power is supplied to the S-MPU 201.

The camera connecting unit 210 is a connecting unit for mounting the external flash 120 on the camera 100, and with the external flash 120 mounted on the camera 100, The camera connecting unit 210 acts as a communication unit via which the S-MPU 201 communicates with the MPU 101 of the camera 100.

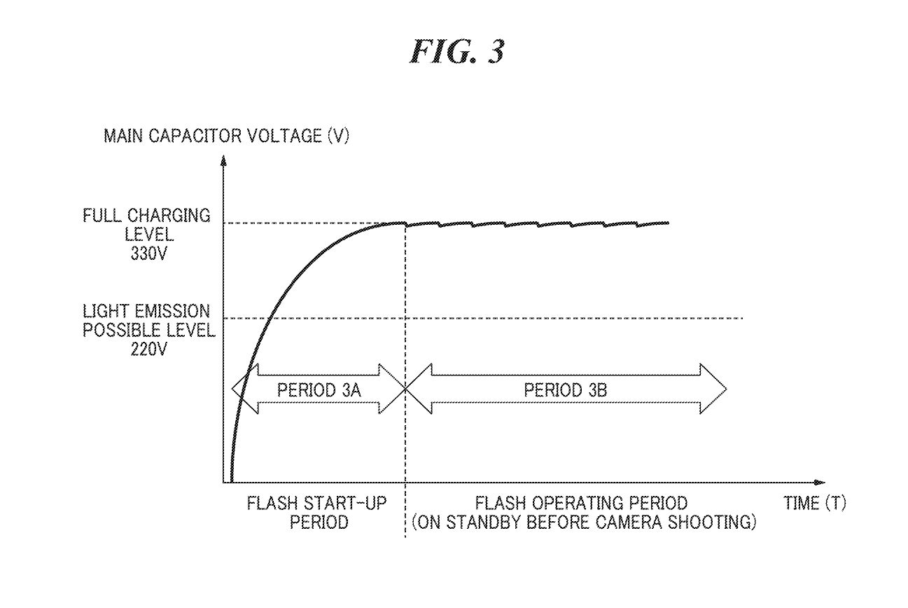

Referring to FIG. 3, a description will now be given of charging control (hereafter referred to as “the first charging control”) that has conventionally been used.

Upon receiving a detection signal indicating turning-on of SW1 from the switch operating unit 116, the MPU 101 instructs the external flash 120 to perform the first charging control.

When the charging voltage is lower than the full charging level as indicated by a period 3A in FIG. 3, the S-MPU 201 that has received this instruction provides control such that the charging unit 202 is charged until the charging voltage reaches the full charging level, and after that, the charging voltage is maintained as indicated by a period 3B in FIG. 3.

In the first embodiment, the S-MPU 201 switches charging control for the charging unit 202 between the first charging control and the second charging control as shown in FIG. 4 (switching unit). Namely, when SW1 is turned on, the S-MPU 201 controls the charging voltage as indicated by a period 4C in FIG. 4 in accordance with the above described instruction to perform the first charging control from the MPU 101 so that a flash photograph can be taken anytime and the best light emission performance can be obtained. On the other hand, when the camera 100 is in the shooting instruction waiting state, the S-MPU 201 controls the charging voltage in accordance with the above described above instruction to perform the second charging control from the MPU 101 so that a minimum charging voltage required to emit a flash light can be maintained. Specifically, first, the charging unit 202 is charged until the charging voltage reaches the full charging level as indicated by a period 4A, and after that, when the charging voltage reaches the light emission level due to self discharge as indicated by a period 4B, the charging unit 202 is charged again until the charging voltage reaches the full charging level.

The period 3A in FIG. 3 and the period 4A in FIG. 4 represent the charging control in a case where the charging unit 202 of the external flash 120 is charged from an empty state for the first time by the S-MPU 201. In this case, in either the first charging control or the second charging control, the charging unit 202 is charged until the charging level reaches the full charging level.

It should be noted that although the full charging level close to the withstand voltage of the main capacitor in the charging unit 202 is the target level in the first charging control and the second charging control, this is not limitative. Namely, a lower level than the full charging level may be the target level as long as the level is higher than the light emission possible level and is a level at which a flash light can be emitted to the maximum extent.

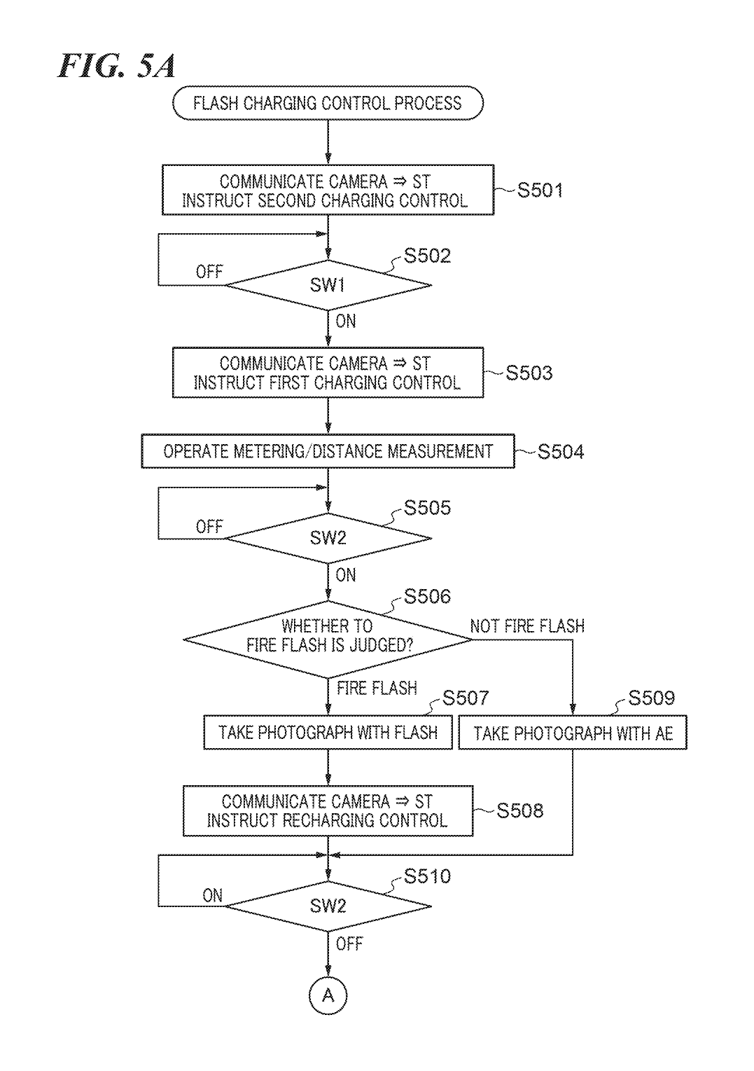

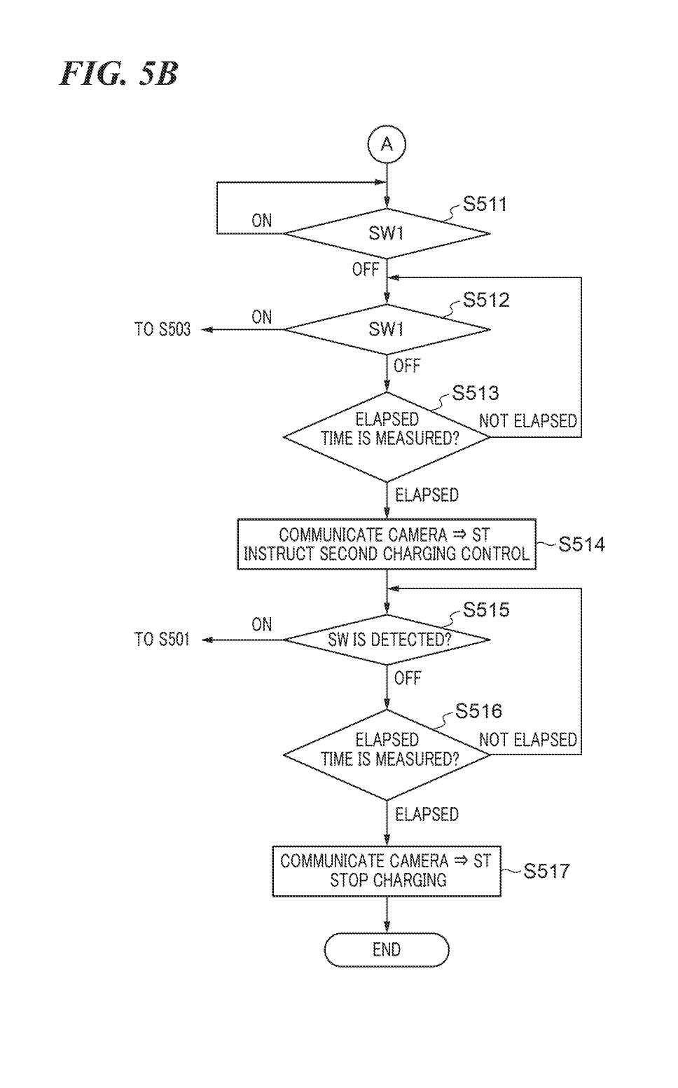

Next, referring to flowcharts of FIGS. 5A and 5B, a description will be given of a charging control process according to the first embodiment in which the first charging control and the second charging control are selectively performed.

This charging control process is started in a state where the camera 100 is placed in a flash photography mode after “Power” is switched on with the power switch of the switching operating unit 116. The external flash 120 is mounted on the camera 100.

First, in step S501, the MPU 101 determines that the camera 100 is in the shooting instruction waiting state and instructs the external flash 120 to perform the second charging control via the flash control unit 118. In accordance with this instruction, the S-MPU 201 starts the second charging control for the charging unit 202. It should be noted that the instruction in the step S501 to perform the second charging control should not always be issued at the time described above as long as it can be judged that communication between the external flash 120 and the MPU 101 has become possible. For example, the instruction in the step S501 may be issued when the user has placed the camera 100 in the flash photography mode in a state where communication between the external flash 120 and the MPU 101 is possible.

In step S502, the MPU 101 waits for the user to press the release switch halfway down and for SW1 to be turned on. When SW1 is turned on, the MPU 101 starts preparing for shooting, and the process proceeds to step S503, in which the MPU 101 in turn instructs the external flash 120 to perform the first charging control. In accordance with this instruction, the S-MPU 201 switches from the second charging control for the charging unit 202, which was started in accordance with the instruction in the step S501 to the first charging control.

In step S504, the MPU 101 performs metering and distance measurement, and in step S505, the MPU 101 waits for the user to press the release switch all the way down and for SW2 to be turned on. When SW2 is turned on, the process proceeds to step S506.

In the step S506, based on the results of metering and distance measurement in the step S504, the MPU 101 judges whether the process will proceed to step S507 in which a flash photograph is taken by emitting light from the external flash 120 or step S509 in which an AE photograph is taken without emitting light from the external flash 120.

As a result of the judgment in the step S506, when the process proceeds to the step S507, the MPU 101 takes a flash photograph, and after that, the process proceeds to step S508 in which the MPU 101 instructs the external flash 120 to charge itself again until the charging voltage reaches the full charging level, followed by the process proceeding to step S510. It should be noted that since the S-MPU 201 is operating based on a program for performing the first charging control in FIG. 3, the external flash 120 is recharged until the charging voltage reaches the full charging level even if the recharging instruction is not issued. On the other hand, as a result of the judgment in the step S506, when the process proceeds to the step S509, the MPU 101 takes an AE photograph, and after that, the process proceeds directly to the step S510.

After that, SW2 and SW1 are turned off in the steps S510 and S511, respectively, the process proceeds to steps S512 and S513, in which the MPU 101 in turn judges whether or not the user has pressed the release switch halfway down again, and SW1 has been turned on again until the lapse of a predetermined time period. When the MPU 101 judges that SW1 has been turned on again until the lapse of the predetermined time period (not elapsed in the step S513, ON in the step S512), the process returns to the step S503. On the other hand, when the predetermined time period has elapsed without SW1 being turned on again (OFF in the step S512, elapsed in the step S513), the MPU 101 determines that it is in the shooting instruction waiting state, followed by the process proceeding to step S514.

In the step S514, the MPU 101 instructs the external flash 120 to perform the second charging control. In accordance with this instruction, the S-MPU 201 switches from the first charging control for the charging unit 202, which was started in accordance with the instruction in the step S503, to the second charging control.

After that, in steps S515 and S516, when other switch of the switch operating unit 116 than the release switch and the power switch has been operated until the lapse of a predetermined time period, the process returns to the step S501. On the other hand, when the predetermined time period has elapsed without the above other switch being operated, the process proceeds to step S517.

In the step S517, the MPU 101 instructs the external flash 120 to stop charging and ends the process.

It should be noted that in the above description of the first embodiment, the charging control process is intended for the external flash 120, but the charging control process may be intended for the built-in flash 119. In the following description, a target for the charging control process according to the first embodiment will be referred to merely as the flash.

According to the charging control process for the flash in the first embodiment described above with reference to FIGS. 5A and 5B, in accordance with an instruction from the MPU 101 of the camera 100, the S-MPU 201 of the flash switches the charging control for the charging unit 202 to one of the first charging control and the second charging control. Here, the instruction from the MPU 101 means an instruction to perform the second charging control in a case where it is determined that the camera 100 is in the shooting instruction waiting state (steps S501, S504). The instruction from the MPU 101 means an instruction to perform the first charging control in a case where the camera 100 has started preparing for taking a photograph (step S503). Thus, in the shooting instruction waiting state, the S-MPU 201 performs the second charging control, and hence draining of the main capacitor caused by charging of the flash can be reduced. Moreover, when SW1 is turned on, the S-MPU 201 performs the first charging control, and hence the perfect moment to take a photograph is never missed.

Further, although according to the present invention, the full charging level is set close to the withstand voltage of the charging unit 202, the full charging level may be set a predetermined level lower than the withstand voltage of the charging unit 202 as long as the best light emission performance of the flash can be obtained.

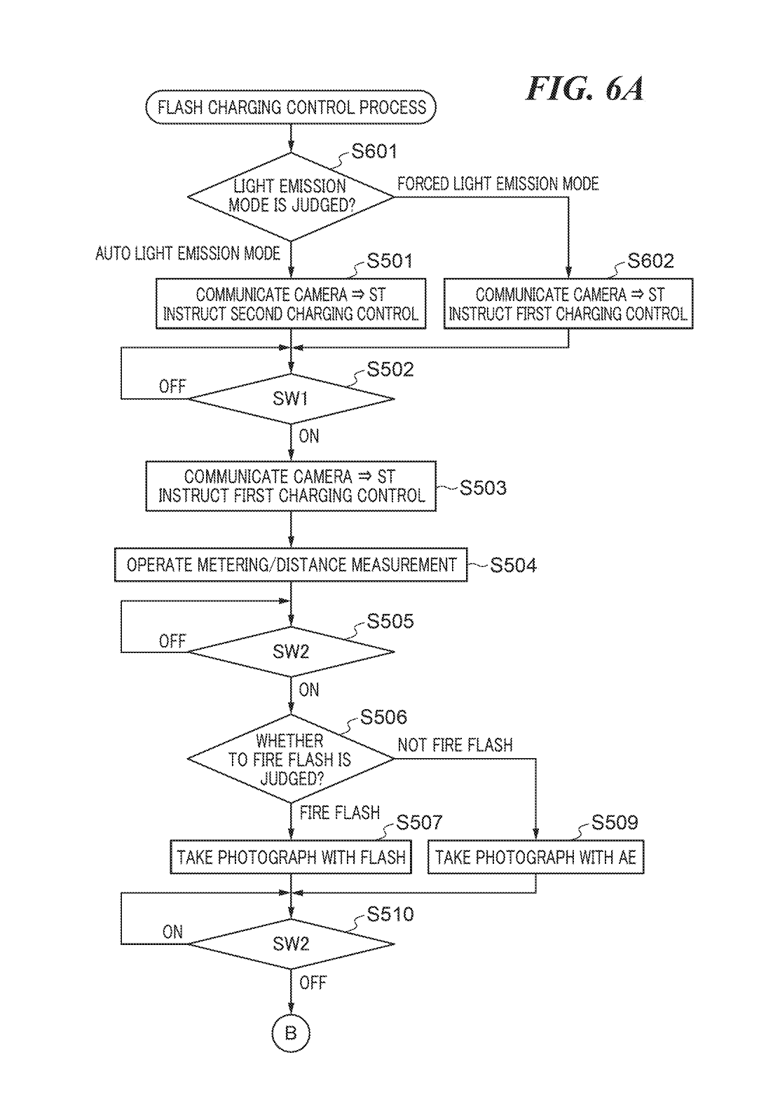

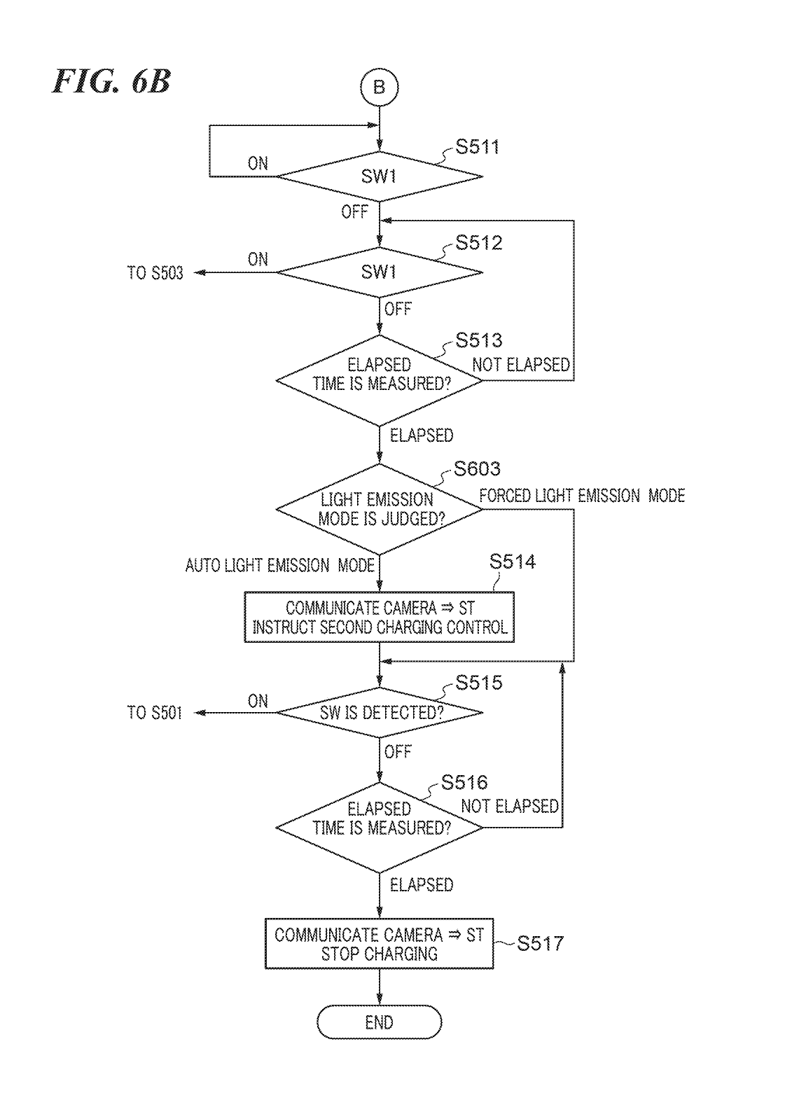

Moreover, the flash may be configured to be placed in one of a plurality of light-emitting modes including an auto light-emitting mode and a forced light-emitting mode (setting unit). Here, the auto light-emitting mode means a light emission mode in which light emission and non-light emission are switched according to a metering result at the time of shooting. The forced light-emitting mode means a light emission mode in which the flash is fired without exception at the time of shooting. In this case, when the flash is in the forced light-emitting mode as in a variation of the charging control process in FIGS. 5A and 5B, which is shown in FIGS. 6A and 6B, only the first charging control is always switched to be performed, and when the flash is in the auto light-emitting mode, the first charging control and the second charging control are selectively performed.

In flowcharts of FIGS. 6A and 6B, only steps S601 to S603 are different from those in the flowcharts of FIGS. 5A and 5B, and therefore, a description will be given below of only the steps S601 to S603. Since the other steps are the same as those in the flowcharts of FIGS. 5A and 5B, the same steps are denoted by the same step numbers, duplicate description thereof is omitted.

First, at the first of the process, upon determining that the camera 100 is in the shooting instruction waiting state, the MPU 101 inquires of the flash if the flash is in the auto light-emitting mode or the forced light-emitting mode. In response to this inquiry, the S-MPU 201 notifies the camera 100 of the light emission mode set for the flash (notification unit). It should be noted that the method using this inquiry should not always be used as long as the auto light-emitting mode currently set for the flash in the camera 100 can be recognized. For example, when the light emission mode set for the flash is changed, the flash may notify the camera 100 of the changed light emission mode.

As a result of this inquiry, when the flash is in the auto light-emitting mode, the process proceeds to the step S501, in which the MPU 101 in turn instructs the flash to perform the second charging control. On the other hand, when the flash is in the forced light-emitting mode, the process proceeds to the step S602, in which the MPU 101 in turn instructs the flash to perform the first charging control. The S-MPU 201 starts charging control for the charging unit 202 in accordance with the instruction.

Then, the MPU 101 carries out the processes in the step S502 to S509. After that, SW2 and SW1 are turned off in the steps S501 and S511, respectively, and when a predetermined time period has elapsed in the step S513 without SW1 being turned on again, the MPU 101 determines that the camera 100 is in the shooting instruction waiting state, followed by the process proceeding to the step S603.

In the step S603, the MPU 101 judges a light emission mode of the flash, and when the flash is in the auto light-emitting mode, the process proceeds to the step S514, in which the MPU 101 in turn instructs the flash to perform the second charging control, followed by the process proceeding to the step S515. It should be noted that when the first charging control has been performed for the charging unit 202 in accordance with the instruction in the step S602, the S-MPU 201 switches the charging control for the charging unit 202 from the first charging control to the second charging control. On the other hand, as a result of the judgment in the step S603, when the flash is in the forced light-emitting mode, the process proceeds to the step S515.

The subsequent processes are the same as those in the flowchart of FIG. 5, and hence description thereof is omitted.

As described above, according to the variation of the charging control process for the flash in the first embodiment shown in FIGS. 6A and 6B, when the MPU 101 determines that the camera 100 is in the shooting instruction waiting state, the MPU 101 judges the light emission mode set for the flash (steps S601, S603). According to a result of the judgment, the MPU 101 gives an instruction to perform the first charging control or the second charging control. Specifically, when the flash is in the auto light-emitting mode, the MPU 101 instructs the flash to perform the second charging control, and when the flash is in the forced light-emitting mode, the MPU 101 instructs the flash to perform the first charging control. Thus, when the camera 100 is in the shooting instruction waiting state and the flash is in the auto light-emitting mode, the S-MPU 201 performs the second charging control, which can reduce draining of the main capacitor caused by charging of the flash. On the other hand, when the flash is in the forced light-emitting mode, the S-MPU 201 performs the first charging control although the camera 100 is in the state of waiting for a shooting instruction, which reliably prevents the perfect moment to take a photograph from being missed.

Moreover, as described above, in the embodiment, the camera 100 which is an interchangeable lens digital camera equipped with an optical finder is taken as an example of the image pickup apparatus implementing the present invention, but this is not limitative.

For example, a digital camera equipped with no optical finder, an integral lens digital camera, or image pickup apparatuses other than the digital camera, such as a movable device such as a digital video camera or a smartphone, a wearable terminal, and a security camera may be adopted.

### Second Embodiment

A second embodiment differs from the first embodiment in that a charging stop level (third level) during a sleep state is provided between the full charging level and the light emission possible level in FIG. 4, and during the sleep state, self discharge is continued until the light emission possible level is reached, and the charging voltage is repeatedly increased until the charging stop level is reached.

Thus, the arrangements of the camera 100 and the external flash 120 in FIGS. 1 and 2 are the same as those in the second embodiment and the first embodiment, and hence the same component elements are denoted by the same reference symbols, and duplicate description thereof is omitted.

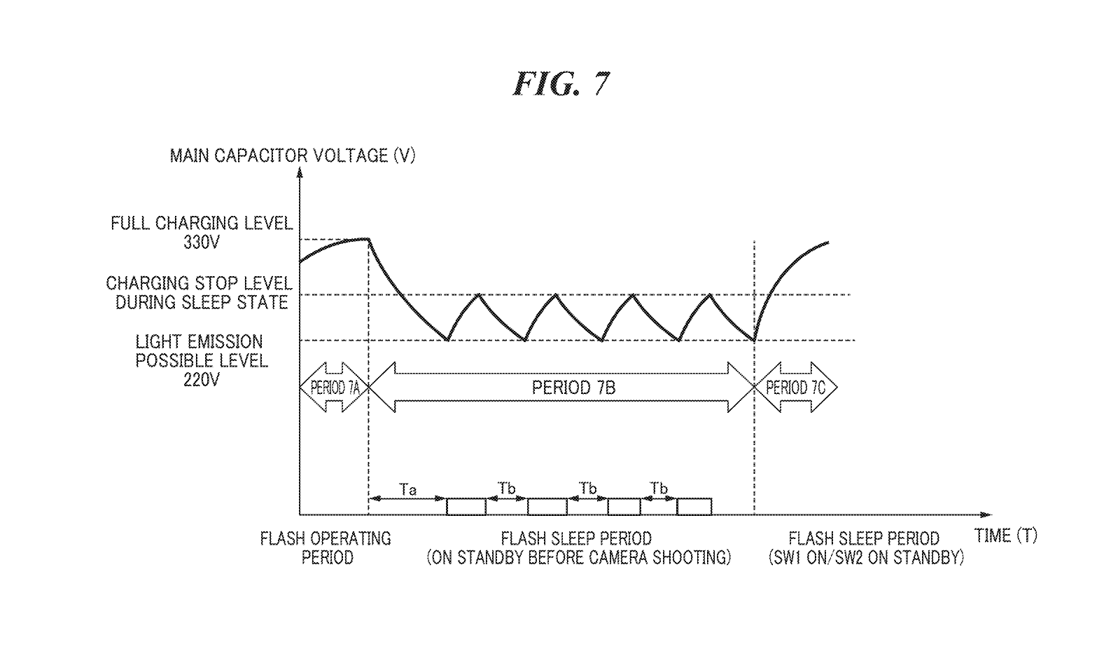

First, referring to FIG. 7, a description will be given of charging control (third charging control) for the flash according to the second embodiment.

Upon receiving a detection signal indicating turning-on of SW1 from the switch operating unit 116, the MPU 101 instructs the external flash 120 to perform the first charging control.

In response to this instruction, the S-MPU 201 performs the first charging control in which it charges the charging unit 202 until the charging voltage reaches the full charging level as indicated by the period 3A in FIG. 3, and then continues to maintain the charging voltage as indicated by the period 3B in FIG. 3.

After that, when no user operation on any other switch or the like which the switch operating unit 116 has other than the release switch and the power switch has been performed for a predetermined time period, the MPU 101 goes into a power saving mode. On this occasion, the MPU 101 turns off the image display unit 107 and gives a power saving mode instruction to the external flash 120.

In response to the power saving mode instruction, the S-MPU 201 performs the third charging control in which it intermittently charges the charging unit 202 up to the charging stop level during the sleep state such that the charging voltage never becomes lower than the light emission level.

A description will now be given of an example of how the third charging control is performed.

First, a time period Ta over which the charging voltage drops from the full charging level to the light emission possible level is calculated based on a discharge curve, not shown, and is set as a next startup time period Ta, and the S-MPU 201 stops the operation thereof to bring the external flash 120 into the sleep state.

After the time period Ta has elapsed since the external flash 120 was brought into the sleep state, the S-MPU 201 resumes the operation to charge the charging unit 202 until the charging voltage reaches the charging stop level.

Next, a time period Tb over which the charging voltage drops from the charging stop level to the light emission possible level is calculated based on a discharge curve, not shown, and set as a next startup time period Tb, and the S-MPU 201 stops the operation thereof to bring the external flash 120 into the sleep state again. After the time period Tb has elapsed since the external flash 120 was brought into the sleep state again, the S-MPU 201 resumes the operation. Then, until conditions listed below are satisfied, the S-MPU 201 repeats the same process as the process carried out after the lapse of the time period Ta since the external flash 120 was brought into the sleep state for the first time after the start of the third charging control. The conditions to stop the repeated process are listed below.

1. The MPU 101 gives an instruction to the S-MPU 201.

2. The number of times the S-MPU 201 has been started since the lapse of the time period Tb (the number of times the charging unit 202 has been recharged) becomes equal to or greater than a predetermined number of times.

3. The external flash 120 is removed from the camera 100.

4. The supply of electric power to the S-MPU 201 is stopped by the user turning off the power switch of the switch operating unit 209 in the S-MPU 201.

When at least one of the conditions 2 to 4 are satisfied, the S-MPU 201 provides control to stop charging and stops the operation thereof, bringing the external flash 120 into the sleep state.

When the condition 1 is satisfied, the S-MPU 201 performs charging control in accordance with the instruction. For example, when the MPU 101 instructs the S-MPU 201 to perform the first charging control, the S-MPU 201 provides control to charge the charging unit 202 until the charging voltage reaches the full charging level as indicated by a period 7C, and then continue to maintain the charging voltage.

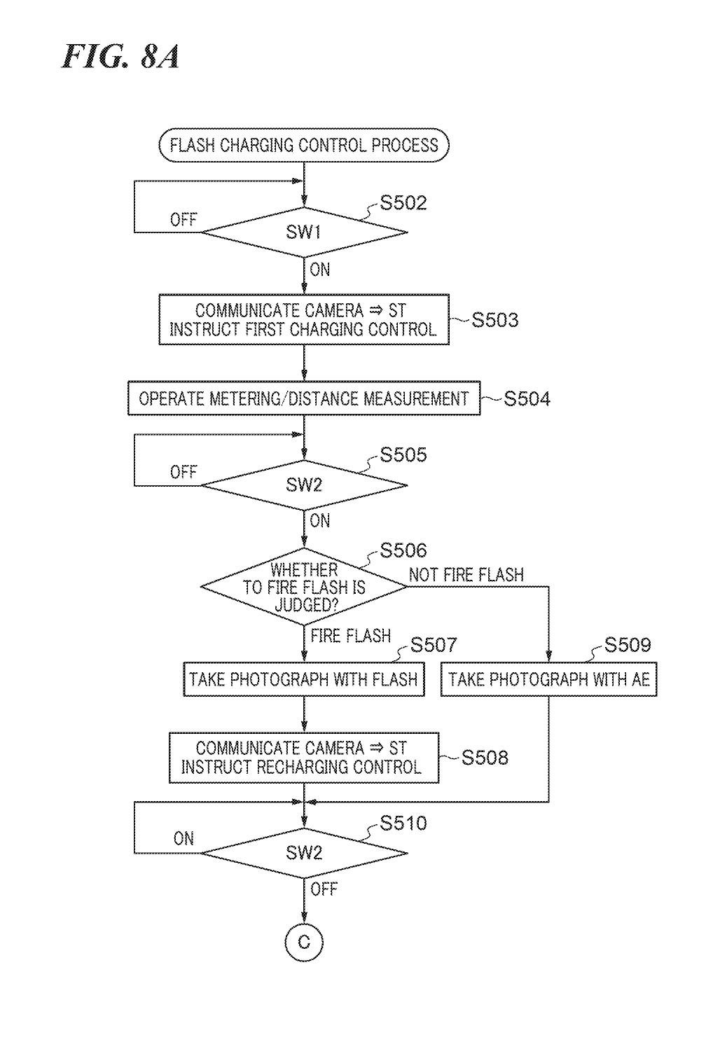

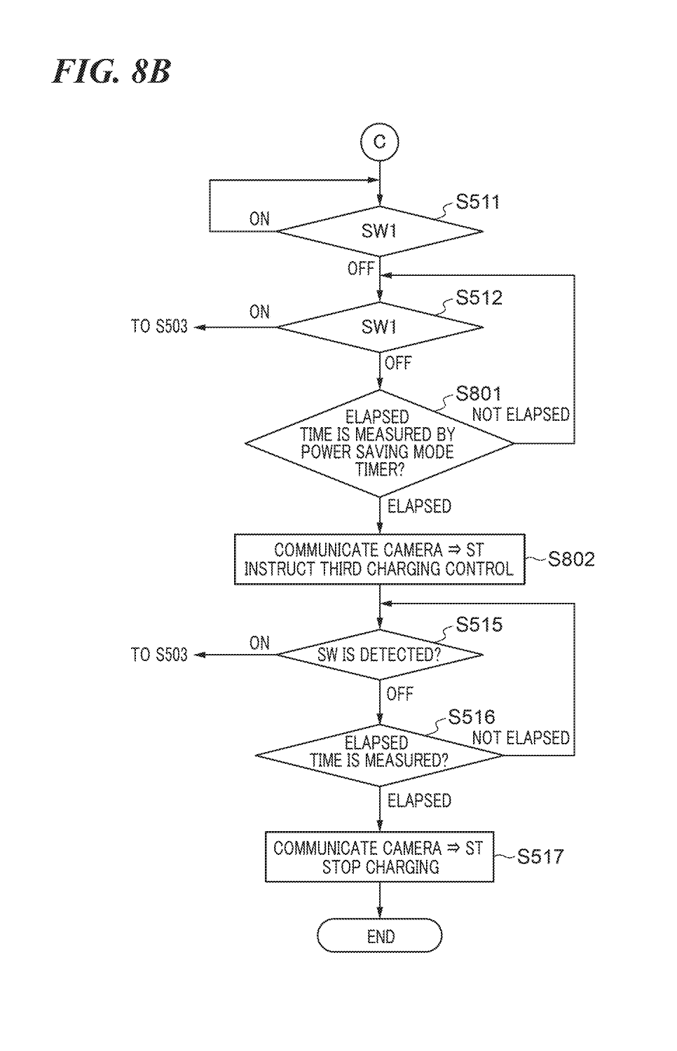

Referring to flowcharts of FIGS. 8A and 8B, a description will now be given of a charging control process according to the second embodiment in which the first charging control and the third charging control are selectively performed.

In this charging control process, the same steps as those in the charging control process according to the first embodiment shown in the flowcharts of FIGS. 5A and 5B are denoted by the same step numbers, and duplicate description thereof is omitted. It should be noted that as distinct from the first embodiment, the charging control process according to the second embodiment is started with the step S502 without the step S501 being not executed.

First, the same processes as those in the charging control process according to the first embodiment are carried out in the steps S502 through S509. Next, when SW2 and SW1 are turned off in the steps S510 and S511, respectively, and a power saving mode timer has expired without SW1 being turned on again (OFF in the step S512, elapsed in the step S801), the process proceeds to step S802.

In the step S802, the MPU 101 turns off the image display unit 107 to shift the camera 100 into the power saving mode and instructs the external flash 120 to perform the third charging control, followed by the process proceeding to the step S515. In accordance with the instruction in the step S602, the S-MPU 201 switches the charging control for the charging unit 202 from the first charging control to the third charging control.

The subsequent processes are the same as those in the flowchart of FIG. 5, and hence description thereof is omitted. However, when any switch of the switch operating unit 116, other than the release switch and the power switch, is operated in the step S515 or S516 before the lapse of a predetermined time period, the process returns to the step S503.

It should be noted that in the description of the second embodiment, the charging control process is intended for the external flash 120, but the charging control process may be intended for the built-in flash 119. In the following description, a target for the charging control process according to the second embodiment will be referred to merely as the flash.

According to the charging control process for the flash in the second embodiment shown in FIGS. 8A and 8B, when shifting the camera 100 into the power saving mode, the MPU 101 instructs the flash to perform the third charging control (step S802). Thus, draining of the main capacitor caused by charging of the flash is reliably reduced because the S-MPU 201 performs the third charging control when the camera 100 is in the power saving mode.

It should be noted that although in the second embodiment, the first charging control and the third charging control are selectively performed, the MPU 101 may instruct the flash to perform the second charging control when the camera 100 is in the shooting instruction waiting state as with the first embodiment. In this case, the flash starts the second charging control in response to this instruction.

### Other Embodiments

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-072585, filed Apr. 4, 2018, which is hereby incorporated by reference herein in its entirety.

What is claimed is:

1. A light-emitting apparatus comprising:
a light-emitter;
a charging unit configured to have a capacitor and to be charged with electrical charge for causing said light-emitter to emit light; and
at least one processor and at least one memory functioning as:
a switching unit configured to switch to perform one of a first charging control and a second charging control, wherein in the first charging control charges said charging unit until a charging voltage of said charging unit reaches a target first level and then maintains the charging level at the first level, and the second charging control charges said charging unit until the charging voltage reaches the first level when the charging voltage reaches a second level lower than the first level.

2. The light-emitting apparatus according to claim 1, wherein the light-emitting apparatus is at least one of a light-emitting apparatus that is mounted on an image pickup apparatus and a light-emitting apparatus that is integral with the image pickup apparatus.

3. The light-emitting apparatus according to claim 1, wherein the first level is a level at which maximum light emission by said light-emitter is possible, and the second level is a level at which light emission by said light-emitter is ensured.

4. The light-emitting apparatus according to claim 2, wherein in a case where the image pickup apparatus is in a shooting instruction waiting state, an instruction to perform the second charging control is issued, and in a case where a user has operated a shooting preparation switch in the shooting instruction waiting state, and the image pickup apparatus has started preparing for taking a photograph, an instruction to perform the first charging control is issued.

5. The light-emitting apparatus according to claim 2, wherein the processor functioning as:
a setting unit configured to set one of a plurality of light emission modes; and
a notification unit configured to notify the image pickup apparatus of the light emission mode set by said setting unit,
wherein in a case where the image pickup apparatus is in a shooting instruction waiting state, one of an instruction to perform the first charging control and an instruction to perform the second charging control is issued according to the light emission mode of which the image pickup apparatus has been notified by said notification unit.

6. The light-emitting apparatus according to claim 5, wherein the plurality of light emission modes includes a first light emission mode in which light emission and non-light emission are switched when a photograph is taken according to a result of photometry by the image pickup apparatus, and a second light emission mode in which a light emission is performed when a photograph is taken,
when the light emission mode of which the image pickup apparatus has been notified is the first light emission mode, said switching unit switches to perform one of the first charging control and the second charging control in accordance with the instruction from the image pickup apparatus, and
when the light emission mode of which the image pickup apparatus has been notified is the second light emission mode, said switching unit switches to perform the first charging control.

7. The light-emitting apparatus according to claim 2, wherein in a case where the image pickup apparatus has been shifted into a power saving mode, the image pickup apparatus issues a second instruction to perform the third charging control, and in accordance with the second instruction, said switching unit switches to perform a third charging control that charges said charging unit until the charging voltage reaches a third level between the first level and the second level, when the charging voltage has reached the second level.

8. The light-emitting apparatus according to claim 7, wherein the processor functioning as:
a stop unit configured to stop charging said charging unit after the third charging control is started, when the number of times said charging unit has been recharged becomes equal to or greater than a predetermined number of times.

9. A charging control method for a light-emitting apparatus comprising a light-emitter, and a charging unit that has a capacitor and is charged with electrical charge for causing the light-emitter to emit light, comprising:
switching to perform one of a first charging control and a second charging control, wherein the first charging control charges the charging unit until a charging voltage of the charging unit reaches a target first level and then maintains the charging level at the first level, and the second charging control charges the charging unit until the charging voltage reaches the first level when the charging voltage reaches a second level lower than the first level.

10. A non-transitory computer-readable storage medium storing a program for causing a computer to execute a charging control method for a light-emitting apparatus comprising a light-emitter, and a charging unit that has a capacitor and is charged with electrical charge for causing the light-emitter to emit light, the method comprising:
switching to perform one of a first charging control and a second charging control, wherein the first charging control charges the charging unit until a charging voltage of the charging unit reaches a target first level and then maintains the charging level at the first level, and the second charging control charges the charging unit until the charging voltage reaches the first level when the charging voltage reaches a second level lower than the first level.
